(19) United States
(12) Patent Application Publication
(10) Pub. No.: US 2025/0237182 A1
(43) Pub. Date: Jul. 24, 2025

(54) OUTLET NOZZLE PROVIDED WITH CHEVRONS FOR AERONAUTICAL THRUSTER

(71) Applicant: SAFRAN AIRCRAFT ENGINES, Paris (FR)

(72) Inventors: Fernando GEA AGUILERA, Moissy-Cramayel (FR); Guillaume Michel Marcel BODARD, Moissy-Cramayel (FR); Jean-Michel Daniel Paul BOITEUX, Moissy-Cramayel (FR)

(73) Assignee: SAFRAN AIRCRAFT ENGINES, Paris (FR)

(21) Appl. No.: 18/697,839

(22) PCT Filed: Sep. 27, 2022
(86) PCT No.: PCT/FR2022/051827

§ 371 Date: Apr. 2, 2024

(30) Foreign Application Priority Data
Oct. 4, 2021 (FR) 2110467

(51) Int. Cl. F02K 1/48

(52) U.S. Cl. CPC F02K 1/48; F05D 2260/96

(57) ABSTRACT

Exhaust nozzle for an aeronautical propulsion system disposed downstream of at least one stator blade of the propulsion system, a trailing edge of the exhaust nozzle including a plurality of chevrons distributed circumferentially around a central axis, said trailing edge including a first trailing edge pattern extending over an angular range Δθ including the at least one stator blade, the first pattern being a portion of the trailing edge including at least one chevron or being a portion of the trailing edge not having a chevron, and a second trailing edge pattern extending over an angular range Δθ′ not including the at least one stator blade, the second pattern being a portion of the trailing edge including at least one chevron or being a portion of the trailing edge not having a chevron, and being distinct from the first pattern.

### TECHNICAL FIELD

The present invention relates to the general field of aeronautical propulsion systems, and applies more particularly, but not solely, to aircraft turbojets and turboprops, particularly of the type with large diameters. In particular, the invention relates to a gas ejection nozzle equipping an aeronautical turbine engine, and relates in particular too the reduction of the jet noise at the exhaust of an ejection nozzle of this type.

### PRIOR ART

For the new generations of commercial airplanes, it is contemplated to use aeronautical propulsion systems with a high bypass ratio, for example bypass ratios greater than 10, and with a large diameter, i.e. having diameters greater than 1.5 m, in order to increase the propulsion efficiency of the turbojets and reducing their fuel consumption, as well as emissions of polluting gases. The aeronautical propulsion systems can be heat engines, in particular turbine engines, turbojets, high bypass ratio turbofans, turbofans that are geared or with a speed reduction gearbox, turbojets with counter-rotating turbines, electric motors, hydrogen engines or hybrid heat and/or electric and/or hydrogen engines. The aeronautical propulsion systems can comprise several engines, and the energy sources of the engines can be kerosene-based fuels, aviation gasoline, diesel, aviation biofuels, electricity or hydrogen. It will be noted that the term “turbojets” designates a gas turbine machine supplying thrust which contributes to propulsion by reaction upon ejection of hot gas at high speed.

Moreover, different types of aeronautical propulsion systems, particularly turbojets, ducted or unducted, can be used:
“Ultra-High Bypass Ratio” (UHBR): a ducted turbojet 100 as illustrated in FIG. 1, with a fixed-pitch fan wheel, with or without a gearbox for reducing the speed of the fan,
“Variable-Pitch Fan” (VPF): ducted turbojet with a variable-pitch fan,
“Counter-Rotating Open Rotor” (CROR): unducted turbojet with two (at least) variable pitch counter-rotating propellers,
“Unducted Stator Fan” (USF): unducted turbofan 100′ as illustrated in FIG. 2, with a variable-pitch propeller wheel 31 and a straightener wheel 32 (stator) with a fixed or variable pitch.

Unducted turboprops can also be used. It will be noted that the term “turboprop” designates a gas turbine based machine the thrust of which is primarily obtained by the traction of a variable-pitch propeller.

A major disadvantage, however, of these integrated architectures on commercial airplanes is their acoustic impact, i.e. noise levels. The sound levels emitted by airplanes are subjected to ever stricter international regulations during the takeoff and landing phases, in order to limit acoustic footprint in proximity to airports. Although the increase in the bypass ratio and the reduction in the speed of rotation of the fan or of the propellers on the unducted architectures has allowed reducing the ejection speed of the secondary flow and improving the mixing of the flows downstream of the turbine engine, and thereby improving the reduction of the jet noise, the latter remains a considerable noise source which must be taken into account in the process of designing an aeronautical turbine engine.

In FIGS. 1 and 2, the jet noise generated is shown by circular arcs drawn in broken lines. With reference to FIG. 1 showing a ducted turbine engine 100, the jet noise is mainly due to the exhaust of air flow at high speed originating in the primary flow F1 (and/or in the secondary flow F2), which produces a high bandwidth noise which dominates at low frequencies. Moreover, the jet interacts with the boundary layer CL which develops on the inner/outer surface on the nacelle 20 (or the casing 10) of the turbine engine, which generates a shear layer CS.

Moreover, the jet can also interact with the wakes at the tip or at the root of the stator blades/airfoils or structural arms, for example the outlet guide vanes 30, or the blades of the exhaust casing 40 (called TRF for “Turbine Rear Frame”) downstream of the low-pressure turbine, in proximity to the outlet plane of one or more nozzles 12, 22 for exhausting the gases of the turbine engine. In fact, the flow at the root or at the tip of a blade can have separation (called “separated” flows or recirculation zones) at certain speeds or operating points of the turbine engine. These phenomena can also contribute to the jet noise. In addition, the aforementioned large diameter turbomachine architectures have a short nacelle in ducted engines in order to reduce drag, which reduces the distance between the stator blades/airfoils 30, 40 and the outlet plane of the nozzle 12, 22 and favors phenomena inducing jet noise.

One solution known per se consists of arranging chevrons along the trailing edge of the exhaust nozzles, allowing a reduction in the jet noise because it favors mixing of the shear layer at the interface of the two flows with different speeds. Moreover, they serve to reduce the trailing edge noise, which is linked to the passage of a turbulent boundary layer by the trailing edge of the casing or of the nacelle.

Nevertheless, despite their advantages, these solutions are not suited to all types of turbine engines, and improvements remain necessary. There exists therefore a need for a solution allowing further improvement in the reduction of the jet noise, and mitigating at least partially the aforementioned disadvantages.

### DISCLOSURE OF THE INVENTION

The present disclosure relates to an exhaust nozzle for an aeronautical propulsion system, the exhaust nozzle being intended to extend around a central axis and to be arranged downstream of at least one stator blade of the propulsion system, a trailing edge of the exhaust nozzle comprising a plurality of chevrons distributed circumferentially around the central axis, said trailing edge comprising:
at least one first trailing edge pattern intended to extend, in an azimuthal direction, over an angular range Δθ including the at least one stator blade, the first pattern being a portion of the trailing edge comprising at least one chevron or being a portion of the trailing edge not having a chevron, and
at least one second trailing edge pattern intended to extend, in the azimuthal direction, over an angular range Δθ′ not including the at least one stator blade, the second pattern being a portion of the trailing edge comprising at least one chevron or being a portion of the trailing edge not having a chevron and being distinct from the first pattern.

In the present disclosure, the terms “upstream,” “downstream” and their derivatives are defined based on a normal flow direction of the air through the turbine engine, along the central axis, i.e. along the axis of rotation of the turbine engine. Likewise, the terms “radial,” “circumference,” “azimuthal direction” and their derivatives are considered with respect to the central axis of the nozzle, in other words with respect to the axis of rotation of the turbine engine with which the central axis of the nozzle can be congruent.

What is meant by “chevron,” is an irregularity along the trailing edge of the nozzle, characterized by the presence of a protrusion (or tip) and/or of a notch (or hollow), with respect to a reference plane defined by the trailing edge in the case where the latter would not comprise any chevron.

Moreover, a trailing edge pattern is a portion of the perimeter of the trailing edge extending over a predetermined azimuthal length, in other words over an angular range, and also having a predetermined geometry. A first pattern is defined as extending over an angular range Δθ including a stator blade arranged upstream of the trailing edge. In other words, in a front view of the exhaust nozzle, perpendicular to the reference plane defined by the trailing edge and parallel to the central axis, the stator blade, then arranged behind the trailing edge in this view, is located inside the angular range Δθ delimiting the first pattern.

In the same manner, according to this same view, the angular range Δθ′ delimiting the second pattern, does not include any stator blade. Thus, when several stator blades are arranged upstream of the exhaust nozzle, each first pattern extends over a range Δθ including one of the stator blades, and each second pattern extends over a range Δθ′ not including a stator blade.

Moreover, the first or the second trailing edge pattern is defined as a portion of the trailing edge comprising at least one chevron, or no chevron. It is understood that in the specific case where the first or the second trailing edge pattern is a portion of the trailing edge not having a chevron, this portion is straight, i.e. comprised in the reference plane defined above. In a preferred embodiment of the invention, the first trailing edge pattern is a portion of the trailing edge not having a chevron, and the second trailing edge pattern is a portion of the trailing edge having at least one chevron.

Thus, according to the present disclosure, the different trailing edge patterns, including chevrons or not, are positioned by taking into account the azimuthal position of the stator blades arranged upstream of the exhaust nozzle, and able to generate jet noise as previously described. In particular, the first and second patterns are different so as to take into account the presence, or not, of a blade upstream of the trailing edge. It is thus possible to adapt the structure of the patterns, particularly the number and/or the shape of the chevrons, depending on the position, the orientation or the shape of the blades, so as to improve the noise reduction. It is in particular possible to adapt the structure of the patterns depending on the local peculiarities of the turbine engine or the specific details of the flow at the exhaust nozzle.

In certain embodiments, a curve of the trailing edge is a curve describing the shape of the trailing edge of the nozzle in a view perpendicular to the central axis, a portion of the trailing edge comprising at least one chevron being an interval of the trailing edge curve in which said curve comprises at least one maximum between the two ends of the interval, and a portion of the trailing edge not having a chevron being an interval of the trailing edge curve in which said curve is constant.

In certain embodiments, the first trailing edge pattern is a portion of the trailing edge comprising at least one chevron, the second trailing edge pattern being different from the first trailing edge pattern by at least one, preferably at least two among the number, the amplitude, the width, the spacing or the geometry of the chevrons.

The presence of structural arms, for example, in the internal air flow upstream of the exhaust nozzle can impact the axial symmetry of the jet. Thus, the fact of arranging the second patterns differing by at least one, preferably two parameters, for example the fact of increasing the number of chevrons and/or increasing the amplitude and/or reducing the spacing or the width of the chevrons locally, near the blades or the elements which can interact with the jet (for example, a pylon, a wing and/or a wing high-lift device) allows improving the mixing of the jet and therefore breaking up the large turbulent structures before interacting with the neighboring elements.

In certain embodiments the first trailing edge pattern and/or the second trailing edge pattern are not homothetic geometric patterns. It is understood, in the specific case, that the second trailing edge pattern is not obtained by a transformation of the first trailing edge pattern resulting from its enlargement or reduction, but preferably from a modification of the number of chevrons and their geometry, for example.

In certain embodiments, the second trailing edge pattern is a portion of the trailing edge comprising at least two chevrons. In a preferred embodiment of the invention, the first trailing edge pattern is a portion of the trailing edge not having a chevron, the second trailing edge pattern being a portion of the trailing edge comprising at least two chevrons.

In certain embodiments, the at least one first pattern and/or the at least one second trailing edge pattern comprises are least two chevrons with different amplitudes and/or widths and/or geometries.

In other words, the same pattern can comprise chevrons distinct from one another, and differing in particular by their amplitude, and/or their width and/or their geometry. It is thus possible to adapt the structure of a pattern depending on the local structure of the flow.

In certain embodiments, when the at least one first and/or the at least one second trailing edge pattern comprise two chevrons so as to form at least one interval between said at least two chevrons, the at least one interval is filled at least partially with a porous material.

In other words, a porous material is arranged in said at least one interval so as to occupy at least partially the space left free between the two chevrons. The porous materials, for example metal foams, have the advantage of having good acoustic absorption properties. In particular, these porous materials allow an effective reduction of wideband and low-frequency noise. These characteristics are particularly advantageous with respect to the jet noise and allow further reduction of the latter. Moreover, the porous materials allow silent expansion of the jets.

In certain embodiments, when the at least one first and/or the at least one second trailing edge pattern comprise two chevrons so as to form at least one interval between said at least two chevrons, the at least one interval is filled at least partially with a plurality of metal slats. In other words, metal slats are arranged in said at least one interval so as to occupy at least partially the space left free between the two chevrons.

In certain embodiments, the metal slats have an amplitude h and a width E such that h/E>10.

In a manner that is an alternative to the porous materials, it is possible to favor a gradual mixing of the jet and thereby attenuate the jet noise by visco-elastic phenomena due to metal slats formed by a plurality of grooves, or slots, provided along the trailing edge of the nozzle, thus forming a metal brush structure allowing reducing the jet noise.

In certain embodiments, the exhaust nozzle comprises an upstream portion, an annular cowling configured to be detachably attached to the upstream portion, a downstream end of the annular cowling comprising the plurality of chevrons.

In other words, the annular cowling comprising the trailing edge of the exhaust nozzle and the plurality of chevrons, is removable with respect to the rest of the nozzle, particularly the upstream portion. It is thus possible to easily remove and replace the chevrons during maintenance operations or in the event of damage to the chevrons.

The present disclosure also relates to an aeronautical propulsion system configured to receive at least one internal air flow, comprising at least one exhaust nozzle according to any one of the preceding embodiments and through which is ejected the at least one internal air flow, and at least one stator blade arranged upstream of the exhaust nozzle.

In certain embodiments, S/C<5, where S is the distance between the trailing edge of the at least one stator blade at a connexion of the stator blade on a casing, or a hub, or a nacelle of the propulsion system and the point of the trailing edge of the exhaust nozzle closest to the stator blade in the direction of the central axis, and C is the chord of the stator blade measured at the connexion.

These ratios allow the propulsion system to be made more compact, particularly by reducing the length of the casing or of the nacelle, also allowing reducing the drag.

In certain embodiments, the aeronautical propulsion system comprises N stator blades, where N≥2, distributed circumferentially around the central axis, N first trailing edge patterns each extending over an angular range Δθ including one of the N blades, and N second trailing edge patterns distinct from the first patterns and each extending over an angular range Δθ′ including none of the N blades, the number of first patterns distinct from one another being comprised between 1 and N, and the number of second patterns distinct from one another being comprised between 1 and N. It will be noted that N can be comprised between 3 and 80.

In other words, the first patterns are arranged at azimuthal positions corresponding to the stator blades, and the second patterns are arranged in an interval between two first patterns, corresponding to azimuthal positions not comprising any stator blade.

In certain embodiments, each angular range Δθ including one of the N blades is centered on a main axis of the blade, and is such that Δθₘᵢₙ≤Δθ≤Δθₘₐₓ, where Δθₘᵢₙ=360/(36*N) and Δθₘₐₓ=360/(N+1), Δθₘᵢₙ, Δθ and Δθₘₐₓ being expressed in degrees.

In certain embodiments, the main axis of the blade is the pitch change axis when the blades are variable pitch stator blades.

The pitch angle of the stator blades can be different, depending on the operating point of the propulsion system, particularly in cruise, on landing or on takeoff. Consequently, a variation of the pitch angle of the blades can give rise to a variation in the direction of flow downstream of the stator blades (if for example the flow is not completely straightened by the stators), or to a variation in the width of the wakes of the stators or of their azimuthal positions at the outlet plane of the nozzle. Thus, these values of the angular range Δθ allow ensuring optimal operation regardless of the variation of the pitch angle of the stator blades.

In certain embodiments, the main axis of the blade is the axis perpendicular to the central axis and passing through the trailing edge of the blade at a connexion of the stator blade on a casing, a hub, or a nacelle of the propulsion system, when the blades are fixed pitch stator blades.

In certain embodiments, the aeronautical propulsion system is a double flow turbojet.

In certain embodiments, the aeronautical propulsion system is a ducted double flow turbojet comprising a first exhaust nozzle through which is ejected a first internal air flow and a second exhaust nozzle through which is ejected a second internal air flow, a trailing edge of each of the first and of the second exhaust nozzle comprising a plurality of chevrons, at least one first stator blade being arranged in the first internal air flow upstream of the first exhaust nozzle, and at least one second stator blade being arranged in the second internal air flow upstream of the first exhaust nozzle and of the second exhaust nozzle, the trailing edge of each of the first and of the second exhaust nozzle comprising at least one first pattern and at least one second trailing edge pattern.

In other words, each of the first and of the second exhaust nozzle comprises first patterns arranged at azimuthal positions corresponding to the positions of the first stator blades and second stator blades respectively. It is thus possible to adapt the structures of the trailing edge patters on each of the exhaust nozzles, depending on the local specificities of each of the internal flows and of each of the nozzles, thus allowing reducing the jet noise of the ducted double flow propulsion system.

In certain embodiments, the aeronautical propulsion system is an unducted double flow turbojet comprising an exhaust nozzle of which an inner surface delimits the internal air flow and of which an outer surface delimits an external air flow, a trailing edge of the exhaust nozzle comprising a plurality of chevrons, at least one first stator blade being arranged in the internal air flow upstream of the exhaust nozzle. It is understood that in the specific case, the first stator blade is a fixed TRF blade of the exhaust casing.

In certain embodiments, the aeronautical propulsion system comprises at least one second stator blade arranged in the external air flow upstream of the exhaust nozzle, the trailing edge of the exhaust nozzle comprising at least one first pattern and at least one second trailing edge pattern, the at least one first pattern being arranged in such a manner that the angular range Δθ over which it extends includes the blade closest axially to the trailing edge, among the at least one first stator blade and the at least one second stator blade.

In certain embodiments, the at least one first pattern is arranged in such a manner that the angular range Δθ over which it extends includes the blade for which the ratio S/C is the lowest, among the at least one first stator blade and the at least one second stator blade. In this specific case, the stator blades attached to the outer face and the inner face of a casing, of a hub or of a nacelle of the unducted propulsion system are likely to generate jet noise at the exhaust nozzle upstream of which it is located. The fact of arranging the different trailing edge patterns depending on the azimuthal positions of the blades closest to the trailing edge of the exhaust nozzle, or the ratio S/C of which is the lowest, allows optimizing the reduction of jet noise.

In certain embodiments, when the exhaust nozzle comprises more than two distinct patterns, the variation of the patters in the azimuthal direction is not monotonic. For example, when the propulsion system comprises N stator blades, N first distinct patterns and N second distinct patterns, in other words a total of 2*N distinct patterns, the variation of the patterns along the circumference of the trailing edge is not solely a reduction of the amplitude of the chevrons, for example, but may alternate between increases and reductions of amplitude, and also comprise variations of the width and/or the spacing and/or the geometry of the chevrons.

In certain embodiments, the exhaust nozzle comprises a third trailing edge pattern extending over an angular range including a pylon for attaching the propulsion system to an aircraft wing, the third trailing edge pattern being a portion of the trailing edge not having a chevron.

When the propulsion system is installed on an aircraft, the presence of a pylon (or mast) and/or of the wing can also have an effect on the expansion of the jet. Consequently, the fact of arranging a third trailing edge pattern, preferably not including a chevron, allows improving the reduction of the jet noise.

### BRIEF DESCRIPTION OF THE DRAWINGS

The invention and its advantages will be better understood upon reading the detailed description given hereafter of different embodiments of the invention given by way of non-limiting examples. This description refers to the pages of appended drawings, in which:

FIG. 1 shows schematically a partial section view of a ducted turbine engine according to the prior art,

FIG. 2 shows schematically a partial section view of an unducted turbine engine according to the prior art,

FIG. 3A shows schematically a partial section view of a ducted turbine engine according to a first embodiment conforming to the invention, and FIG. 3B shows schematically a partial section view of an unducted turbine engine according to the first embodiment,

FIG. 4 shows schematically a side view of an exhaust nozzle of the turbine engine of FIG. 3A,

FIG. 5 shows schematically a side view and a rear view, with respect to the central axis of the turbine engine, of an example of an unducted turbine engine conforming to the first embodiment,

FIGS. 6A to 6H show schematically rear views of the unducted turbine engine of FIG. 5, according to different examples conforming to the first embodiment,

FIGS. 7A to 7F show schematically side views of the exhaust nozzle of the unducted turbine engine of FIG. 5, according to different examples conforming to the first embodiment,

FIG. 8 shows schematically side views of an exhaust nozzle illustrating alternative examples conforming to the first embodiment,

FIG. 9 shows schematically a rear view of the turbine engine of FIG. 3A, according to an example conforming to the first embodiment,

FIG. 10 shows schematically side view of an exhaust nozzle of a turbine engine conforming to a second embodiment,

FIG. 11 shows schematically side views of an exhaust nozzle of a turbine engine conforming to a third embodiment,

FIG. 12 shows schematically side views of an exhaust nozzle of a turbine engine conforming to a fourth embodiment.

### DESCRIPTION OF THE EMBODIMENTS

A first embodiment conforming to the present disclosure will be described with reference to FIGS. 3A to 9. In the non-limiting examples described below, the aeronautical propulsion systems are turbine engines. Subsequently in the disclosure, the terms “upstream,” “downstream” and their derivatives are defined with respect to the direction of flow of the gases in the turbine engine along the central axis A of the turbine engine. In addition, the terms “radial,” “circumferential,” “azimuthal direction” and their derivatives are also defined with respect to the central axis A.

FIGS. 3A and 3B show respectively a ducted (of the UHBR or VPF type for example) and unducted (of the CROR or USF type for example) turbine engine, to which a device conforming to the present disclosure can be applied.

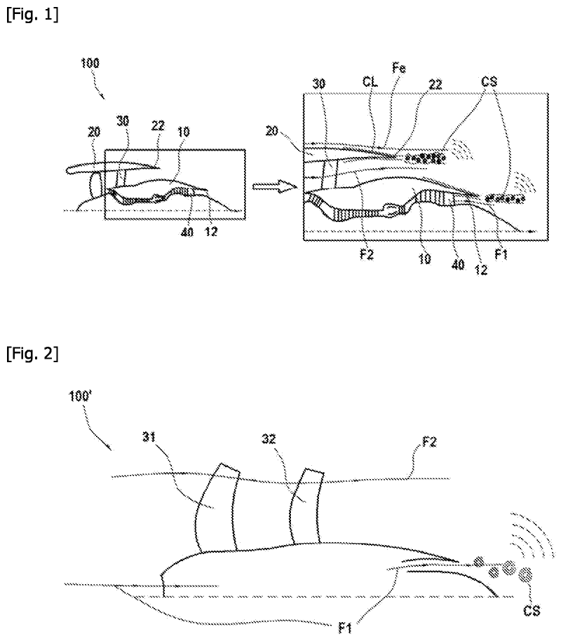

In particular, FIG. 3A shows a ducted double flow turbine engine 1, with central rotation axis A. In the same manner as for the turbine engine according to the prior art described with reference to FIG. 1, it comprises in particular a casing 10 of which the inner surface delimits a primary internal flow, and a nacelle 20 of which the inner surface delimits a secondary internal flow. A first exhaust nozzle 12 is arranged at a downstream end of the casing 10, the primary internal flow being ejected through said first exhaust nozzle 12. A second exhaust nozzle 22 is arranged at a downstream end of the nacelle 20, the secondary internal flow being ejected through said second exhaust nozzle 22.

At least one fixed blade of the exhaust casing 40 (called a TRF blade in the rest of the description) is arranged in the primary internal flow, upstream of the first exhaust nozzle 12, more precisely upstream of a trailing edge 122 of the first exhaust nozzle 12. The TRF is the last bladed wheel in the primary internal flow of the turbine engine 1, located downstream of the low-pressure turbine and allowing removing the high-temperature air originating in the combustion chamber and in the high/low pressure turbine stages. The number of TRF blades 40 is typically on the order of 10.

At least one outlet guide vane 30 (called OGV in the rest of the description) is arranged in the secondary internal flow, upstream of the second exhaust nozzle 22, more precisely upstream of a trailing edge 222 of the second exhaust nozzle 22. The OGV is a fixed wheel arranged downstream of the fan 2, in the secondary internal flow of the ducted turbine engine 1, and allowing straightening the gyration of the flow. The number of blades 30 that the OGV wheel comprises can be comprised between 30 and 60. This example is not limiting, the invention being able to be applied to exhaust nozzles arranged downstream of the structural arms, themselves arranged downstream of the OGVs, or integrated with the OGVs.

Moreover, S1 represents the distance between the trailing edge of a blade 40 at its connexion on the inner face of the casing 10, and the point on the trailing edge 122 of the first exhaust nozzle 12 closest to the blade 40, in the direction of the central axis A. C1 is the chord of the blade 40 measured at said connexion. In other words, C1 is the axial distance between the leading edge and the trailing edge of the blade 40 at said connexion. S2 represents the distance between the trailing edge of a blade 30 at its connexion in the outer face of the casing 10, and the point on the leading edge 122 of the first exhaust nozzle 12 closest to the blade 30. C2 is the chord of the blade 30 measured at said connexion. Finally, S2′ represents the distance between the trailing edge of the blade 30 at its connexion on the inner face of the nacelle 20, and the point on the trailing edge 222 of the second exhaust nozzle 22 closest to the blade 30. C2′ is the chord of the blade 30 measured at said connexion.

FIG. 3B shows an unducted double flow turbine engine 1′, with central axis of rotation A. It comprises a casing 10′ the inner surface of which delimits a primary internal flow, and the outer surface of which delimits a secondary outer flow. An exhaust nozzle 12′ is arranged at a downstream end of the casing 10′, the primary inner flow being ejected through said exhaust nozzle 12′.

The turbine engine 1′ comprises an unducted propeller having a plurality of rotor blades 31, preferably with pitch variable around a pitch change axis X1. In the present example, the unducted turbine engine 1′ is of the USF type comprising stator blades 32 arranged downstream of the rotor blades 31. The stator blades 32 (or straighteners, or SRV for “swirl recovery vanes”) are preferably attached with pitch variable around a pitch change axis X2. The invention is nevertheless applicable to fixed pitch stator blades 32. The number of blades 32 is preferably comprised between 5 and 20.

In addition, in the same manner as the ducted turbine engine, at least one fixed TRF blade 40 is arranged in the primary internal flow, upstream of the exhaust nozzle 12′, more precisely upstream of a trailing edge 122′ of the exhaust nozzle 12′.

Moreover, S1 represents the distance between the trailing edge of a blade 40 at its connexion on the inner face of the casing 10′, and the point of the trailing edge 122′ of the exhaust nozzle 12′ closest to the blade 40, in the direction of the central axis A. C1 is the chord of the blade 40 measured at its connexion. Likewise, S2 represents the distance between the trailing edge of a blade 32 at its connexion on the outer face of the casing 10′, and the point on the trailing edge 122′ of the exhaust nozzle 12′ closest to the blade 32. C2 is the chord of the blade 32 measured at said connexion.

Each of the turbine engines conforming to the present disclosure and shown in FIGS. 3A and 3B are large diameter turbine engines, having a main diameter D, which can be the diameter of the fan in the case of the ducted turbine engine, or the diameter of the upstream rotor in the case of the unducted turbine engine, such that D≥1.5 m. In addition, the dimensions Si (where Si=S1, S2 or S2′) and Ci (where Ci=C1, C2 or C2′) are such that the ratio Si/Ci is comprised between 0 and 15. Preferably Si/Ci<5. The value of this ratio allows reducing the distance between the stator blades 30, 32, 40 and the outlet plane of the nozzles. Nevertheless, this also favors an increase in the jet noise.

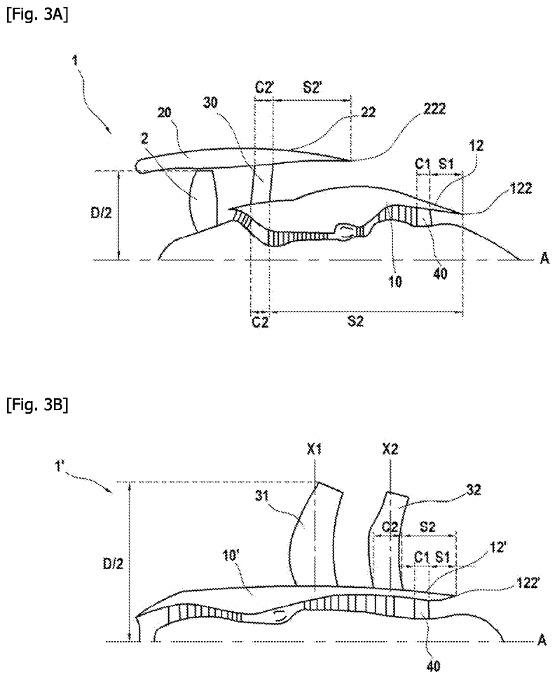

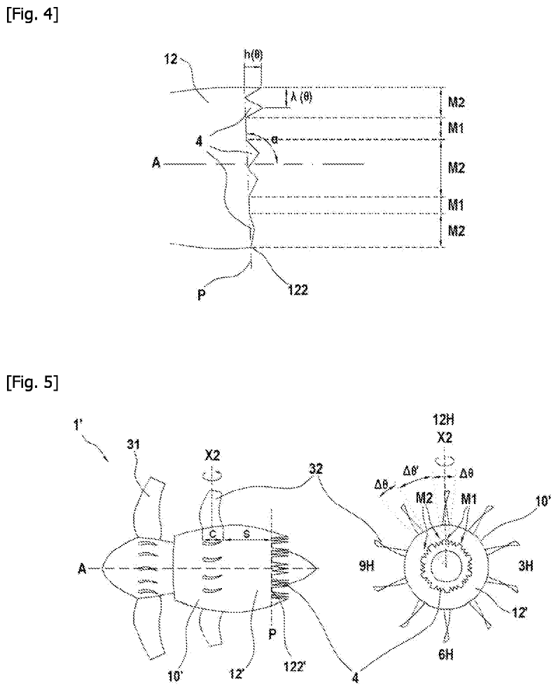

Thus, for reducing the jet noise, the exhaust nozzles conforming to the present disclosure comprise, along their trailing edge, a plurality of chevrons 4 distributed circumferentially around the central axis A, showing both the central axis of the nozzle 12, 12′, 22 and the axis of rotation of the turbine engine 1, 1′. FIG. 4 shows a trailing edge 122 of the exhaust nozzle 12 of FIG. 3A. This example is not limiting and could be applied in the same manner to the exhaust nozzle 22 of the nacelle 20, or to the exhaust nozzle 12′ of the unducted turbine engine 1′.

A chevron 4 corresponds to an irregularity along the trailing edge 122, characterized by the presence of a protrusion and/or of a notch, with respect to a reference plane P defined by the trailing edge 122 in the case where the latter would not comprise any chevron. It will be noted that the reference plane P forms an angle α with respect to the central axis A, the angle α being able to be equal to 90° or different from 90°, in such a manner that the outlet plane of the nozzle can be inclined relative to the central axis A. Preferably, the angle α is comprised between 40° and 140°. In addition, the chevrons 4 can extend downstream parallel to the central axis A, or be inclined relative to the latter. In particular, the angle between the axis along which the chevron 4 extends downstream and the central axis A can be comprised between −60° and 60°, preferably between −15° and 15°.

Thus, in the example shown in FIG. 4, the chevrons 4 are protrusions projecting downstream from the reference plane P. The geometry of the chevrons 4 is not limited, the latter can have a triangular (as in FIG. 4), corrugated or serrated shape, for example. The chevrons 4 can also vary in their amplitude, i.e. their axial length from the reference plane P, their width, i.e. their azimuthal length along the trailing edge 122 at the plane P, or their spacing, i.e. the azimuthal distance between the tips (or the hollows) of two adjacent chevrons 4. In this regard, an amplitude h of the chevrons 4 is defined, and in particular an amplitude h(θ), which is the amplitude of a chevron 4 as a function of the azimuthal position θ along the trailing edge 122. Also defined is a spacing λ between two chevrons, and in particular a spacing λ(θ), which is the spacing between the tips of two adjacent chevrons 4 as a function of the azimuthal position θ along the trailing edge 122. It is thus understood that the geometry, the amplitude, the width or the spacing of the chevrons can vary as a function of the azimuthal position θ along the trailing edge.

It will be noted that the function h(θ) can be a combination of linear, parabolic, sinusoidal, hyperbolic, exponential or logarithmic functions. For example, the amplitude of the chevrons can be defined by the following function: h(θ)/hₘₐₓ=180−∥θ∥/180*sin(θM+δ)+1/2.

Where hₘₐₓ is a maximum amplitude, δ is a dephasing angle, M the total number of chevrons, and θ is the azimuthal angle in degrees, which can vary between −180° and 180°. In this configuration, θ=0° corresponds to the azimuthal position at 12 H (12 o'clock) and θ=+/−180° corresponds to the azimuthal position at 6 H (6 o'clock).

Moreover, the trailing edge 122 comprises at least one first trailing edge pattern M1, and at least one second trailing edge pattern M2. In the example shown in FIG. 4, two first patterns M1 and three second patterns M2 are visible. In the present disclosure, the first pattern M1 is characterized by a portion of the trailing edge 122 comprising at least one chevron 4, or a portion of the trailing edge 122 not having a chevron. In the example illustrated in FIG. 4, the first pattern M1 corresponds to a portion of the trailing edge 122 not comprising a chevron 4. In other words, the trailing edge 122 remains comprised in the reference plane P in this portion. Moreover, the second pattern M2 is characterized by a portion of the trailing edge 122 comprising at least one chevron 4, and is distinct from the first pattern M1.

The first and second patterns M1 and M2 alternate one after the other around the axis A in the azimuthal direction. Thus, a first pattern M1 is necessarily arranged between two second patterns M2, and conversely. It will also be noted that not only are the patterns M1 and M2 different from one another, but each of the first patterns M1 are not necessarily to each other, and each of the second patterns M2 are also not necessarily identical to each other. Thus, the two first patterns M1 visible in FIG. 4 are identical and are portions of the trailing edge 122 with no chevrons 4. On the other hand, the second patterns M2 are different from one another. In particular, among the second patterns M2 visible in FIG. 4, two comprise two chevrons 4, with different amplitudes h, and another comprises a single chevron 4, with a different amplitude h and width from the two other patterns M2.

It is thus possible to determine suitable arrangements and structures of the patterns M1, M2 allowing improving the reduction of the jet noise, depending on the local specificities of the turbine engine and of the flow. FIG. 5 illustrates in more detail the manner in which the first patterns M1 and the second patterns M2 are respective arranged relative to the stator blades.

The non-limiting example shown in FIG. 5 is an unducted turbine engine 1′ of the USF type, the characteristics of which, identical to the turbine engine shown in FIG. 3B, will not be repeated. It will be noted that the distance S between the trailing edge of the blades 32 and the point of the trailing edge 122′ of the exhaust nozzle 12′ closest to the blade 32, and the chord C of the blades 32 measured at their connexion, satisfy S/C<5. In this example, the trailing edge 122′ comprises a plurality of chevrons 4 protruding from the reference plane P.

According to the invention, the number and the structure of the patterns are determined as a function of the number N and of the azimuthal position of the stator blades, in particular the blades satisfying the relation Si/Ci<5. In the examples shown in FIG. 5, N=10, where N is the number of blades 32. The number of first patterns M1 different from one another is comprised between 1 and N. Likewise, the number of different patterns M2 different from one another is comprised between 1 and N. In other words, the total number of different patterns can be comprised between 2 and 2*N. Thus, in the example illustrated in FIG. 5, there are only two different patterns, the first patterns M1 all being identical to one another, and the all the second patterns M2 also being identical to one another. Nevertheless, as previously indicated, this configuration is not limiting, the patterns M1 and M2 respectively being able to be different from one another.

Moreover, the first patterns M1 are arranged in such a manner that each of them extends in the azimuthal direction over an angular range Δθ, preferably centered on the pitch change axis X2 of a blade 32, including this blade 32. In other words, in a rear view of the turbine engine parallel to the central axis A, corresponding to the right view of FIG. 5, each blade 32 is arranged inside the interval delimited by the angular range Δθ, defining the first pattern M1. It will be noted, moreover, that Δθ is such that Δθₘᵢₙ≤Δθ≤Δθₘₐₓ, where Δθₘᵢₙ=360/(36*N) and Δθₘₐₓ=360/(N+1), in order to provide optimal operation regardless of the variation of the pitch angle of the blades 32 around the pitch change axis X2 of each blade.

Likewise, the second patterns M2 are arranged in such a manner that each of them extends in the azimuthal direction over an angular range Δθ′ not including a blade 32. In other words, in a rear view parallel to the central axis A, no blade 32 is arranged inside the interval delimited by the angular range Δθ′, defining the second pattern M2. It will also be noted that N*Δθ+N*Δθ ′=360°.

In the example illustrated in FIG. 5, the first patterns M1 are all identical to one another as indicated above, and characterized by a portion of the trailing edge 122′ not comprising a chevron 4. In other words, over the angular ranges Δθ including the blades 32, i.e. at the azimuthal positions corresponding to the blades 32, the trailing edge 122′ does not comprise a chevron 4. In addition, the second patterns M2, also all identical to one another, are characterized by a portion of the trailing edge comprising three chevrons 4. In other word, over the angular ranges 40′ not including the blades 32, i.e. at the azimuthal positions corresponding to the space between two blades 32, the trailing edge 122′ comprises three chevrons 4.

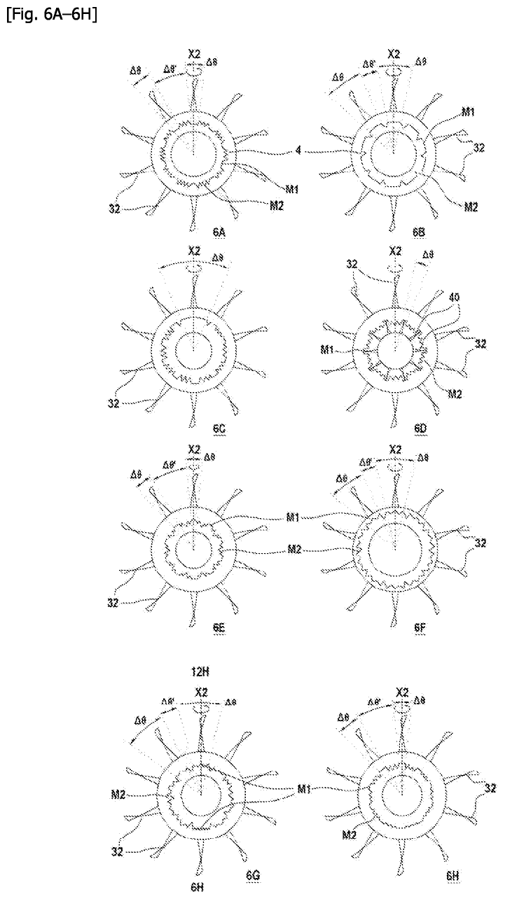

It will also be noted that for each second pattern M2, the three chevrons 4 are identical to one another, and have in particular the same amplitude, the same geometric shape and the same width. This configuration, however, is not limiting, as indicated in the rest of the description, describing different exemplary embodiments conforming to the invention, with reference to FIGS. 6A to 6H, 7A to 7F and 8.

FIG. 6A shows a configuration in which the first patterns M1 are identical to one another and correspond to portions of the trailing edge with no chevron. On the other hand, the second patterns M2 are not all identical to one another, the latter being able to comprise three or four chevrons 4. It will be noted that, in this example, the chevrons 4 correspond to notches along the trailing edge.

FIG. 6B shows a configuration in which the first patterns M1 are identical to one another and correspond to portions of the trailing edge with no chevron, the angular range Δθ of which over which the first patterns M1 extend in the azimuthal direction is greater than in the examples illustrated in FIGS. 5 and 6A. Moreover, the second patterns M2 are also all identical to one another, and each comprises one chevron 4. It will be noted that, alternatively, the first patterns M1 could each comprise one chevron 4, the second patterns M2 then having no chevron.

FIG. 6C shows an alternative example similar to the example of FIG. 5, but of which one angular range Δθ at 12 H (12 o'clock) is locally greater, and corresponds to a third pattern. The latter is arranged at an azimuthal position corresponding to the pylon or mast attaching the turbine engine to the aircraft, in order to take into account the presence of this pylon which could also interact with the jet and increase the jet noise. A fourth pattern comprises a single chevron is also arranged on either side of the third pattern.

FIG. 6D shows a configuration applicable in particular to an unducted turbine engine, particularly the turbine engine illustrated in FIG. 3B. In the specific case, the straightener blades 32 and the TRF blades 40 respectively satisfy the relation S1/C1<5 and S2/C2<5, with S1/C1<S2/C2. In this case, the first patterns M1 are preferably arranged taking into account the azimuthal position of the blades closest to the trailing edge 122′, or those for which the ratio S/C is smallest. The selection of one or the other of these criteria can be carried out depending on the noise source considered to be dominant, and for which the acoustic gain is the greatest. Thus, in FIG. 6D, the first patterns M1 are all identical and have no chevron, and extend over an angular range Δθ including the TRF blades 40. The second patterns M2 extend over an angular range including no TRF blade 40. The second patterns M2 are all identical can comprise three chevrons 4 having a geometry different from that illustrated in FIGS. 6A to 6C, particularly a corrugated geometry.

FIG. 6E shows a configuration in which the first patterns M1 are identical to one another and correspond to portions of the trailing edge having no chevron. The second patterns M2 are also identical to one another, and correspond to portions of the trailing edge comprising three chevrons 4, said chevrons not being identical to one another. More precisely, for the same second pattern M2, one of the chevrons 4 has a greater amplitude and width than the two other chevrons 4 of this same second pattern M2.

FIG. 6F shows a configuration in which the first patterns M1 are identical to one another and correspond to portions of the trailing edge comprising two chevrons 4. The second patterns M2 are also identical to one another, and correspond to portions of the trailing edge comprising one chevron 4, the amplitude of this chevron being greater than the amplitude of the chevrons 4 of the first patterns M1.

FIG. 6G shows a configuration in which all the first patterns M1 are not identical to one another. For example, the first pattern M1 arranged at 12 H (12 o'clock) comprises two chevrons with a triangular shape, other first patterns M1 comprising two chevrons with a corrugated shape. Moreover, the first pattern M1 arranged at 6 H (6 o'clock) comprises a greater number of chevrons 4, with smaller widths and spacings that for the other first patterns M1. The second patterns M2 are identical to one another, and correspond to portions of the trailing edge comprising one chevron 4.

FIG. 6H shows a configuration in which the first patterns M1 are identical to one another and correspond to portions of the trailing edge with no chevron. The second patterns M2 are not identical to one another, and correspond to portions of the trailing edge comprising three chevrons 4, with amplitudes that differ from one pattern M2 to another, and decrease downward in particular, i.e. from 12 H (12 o'clock) to 6 H (6 o'clock).

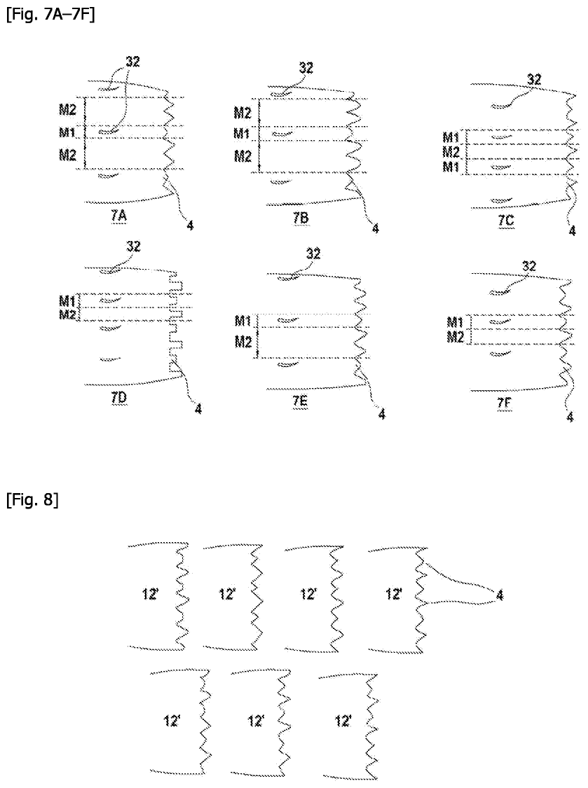

FIGS. 7A to 7F show alternate examples of structures of first patterns M1 and of second patterns M2. In FIG. 7A, the first patterns M1 comprise one chevron 4, and the second patterns M2 comprise two chevrons 4 with a greater amplitude than the amplitude of the chevron 4 of the first patterns M1. The configuration of FIG. 7B is similar to that of FIG. 7A, but differs from the latter by the shape of the chevrons 4, the chevrons 4 having a curved or sinusoidal, and not pointed end. In FIG. 7C, the first patterns M1 and the second patterns M2 each comprise a chevron 4, with an identical pointed shape, but with different amplitude. In FIG. 7D, the first patterns M1 and the second patterns M2 each comprise a chevron 4, with an identical serrated shape, but with different amplitude. In FIG. 7E, the chevrons 4 have a corrugated shape. The first patterns M1 comprise a chevron 4, and the second patterns M2 comprise two chevrons 4 of greater amplitude. In FIG. 7F, the chevrons have a corrugated shape. The first patterns M1 and the second patterns M2 each comprise one chevron 4, with different amplitude.

FIG. 8 shows other alternate examples of first and second patterns M1, M2 distributed on the trailing edge of the exhaust nozzle 12′, of which the chevrons 4 have different geometries and/or amplitudes. The advantage of chevrons having different geometries is to be able to reduce the correlation of the noise sources along the trailing edge of the nozzle. This is useful for reducing the noise generated during the passage of the boundary layer by the trailing edge of the nozzle, as well as favoring jet mixing.

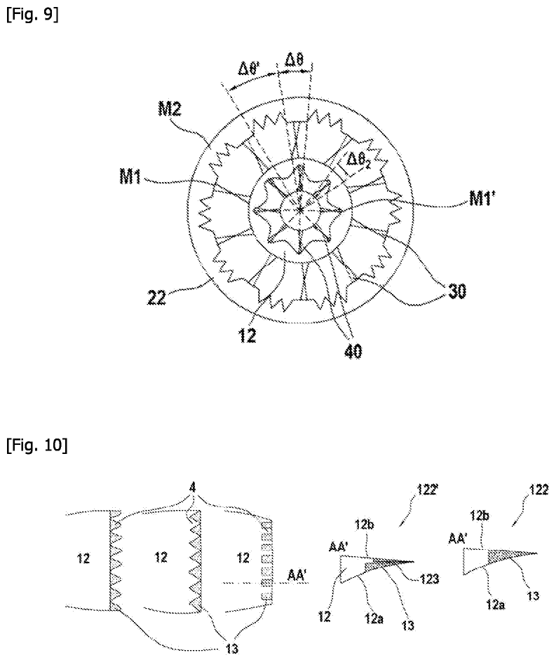

FIG. 9 corresponds to the case of a ducted double flow turbine engine 1 shown in FIG. 3A, comprising a first exhaust nozzle 12 and a second exhaust nozzle 22. Each of the exhaust nozzles 12, 22 comprises, along its respective trailing edge 112, 222, first patterns M1 and second patterns M2. In particular, the first patterns M1 of the second nozzle 22 have no chevron and extend over an angular range Δθ, corresponding to the azimuthal positions of the OGV blades 30, and the second patterns M2 of the second nozzle 22 extend over an angular range Δθ′ and comprise three chevrons 4, corresponding to notches along the trailing edge 222. Moreover, the chevrons 4 of the trailing edge 122 of the first nozzle 12 correspond to corrugations in the trailing edge, the first patterns M1′ of the first nozzle 12 corresponding to the hollow of the corrugations extending over an angular range Δθ₂, corresponding to the azimuthal positions of the TRF blades 40.

A second embodiment conforming to the present disclosure is then described with reference to FIG. 10, showing on the one hand (on the left portion of FIG. 10) three nozzle 12 trailing edges comprising chevrons 4, and on the other hand (on the right portion of FIG. 10), two examples of a detailed view of the trailing edge 122, 122′ in a radial section plane AA′. In order to simplify the description of this embodiment, the chevrons 4 are shown identical to one another, without distinct patterns. It will nevertheless be understood that the description of the second embodiment below applies to the different examples described previously with reference to the first embodiment.

In this embodiment, the space between two chevrons 4 is filled at least partially, totally filled in this example, with a porous material 13. In an alternative example, corresponding to the nozzle farthest to the left in FIG. 10, the chevrons 4 themselves comprise the porous material 13. The porous material can be a metal foam which can be permeable between the inner 12a and outer 12b faces of the trailing edge 122 of the nozzle 12 in order to favor mixing of the flow and attenuate noise by visco-thermal effects in the cavities 30 of the porous material. Alternatively, the porous material 13 can be located on the inner face 12a of the trailing edge 122′, delimiting the primary flow, and/or on the outer face 12b of the trailing edge 122′, delimiting the secondary flow, while being isolated from the inner 12a or outer 12b face by an extension 123 of the trailing edge 122′. This 21 allows limiting the interference of the porous material 13 on the boundary layer on the secondary flow and/or on the jet.

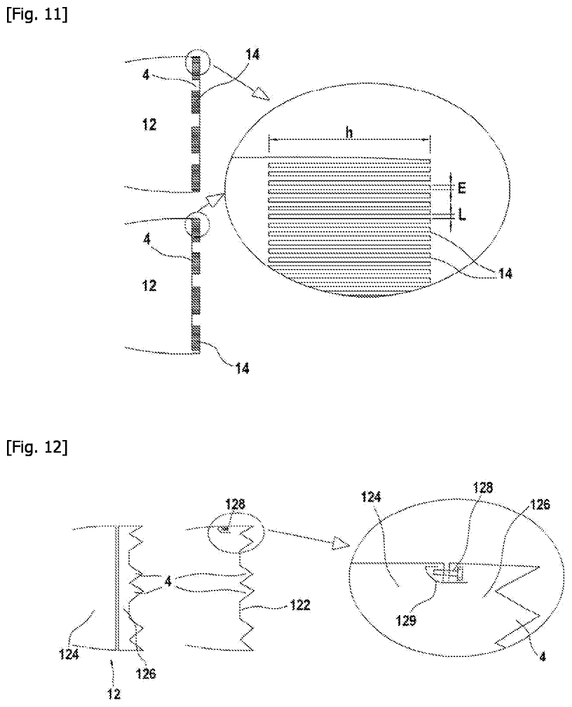

A third embodiment conforming to the present disclosure is described with reference to FIG. 11, showing on the one hand (on the left portion of FIG. 11) two nozzle 12 trailing edges comprising chevrons 4, and on the other hand (on the right portion of FIG. 11), a detailed view of a trailing edge conforming to the third embodiment. In order to simplify the description of this embodiment, the chevrons 4 are shown identical to one another, without distinct patterns. It will nevertheless be understood that the description of the third embodiment below applies to the different examples described previously with reference to the first embodiment.

In this embodiment, the space between two chevrons 4 is filled at least partially, totally filled in this example) with metal slats 14, the latter being able to be formed by slots created along the trailing edge. In an alternative example, corresponding to the lower nozzle in FIG. 10, the chevrons 4 themselves comprise metal slats 14. The plurality of metal slates 14 thus forms a metal brush in which each slat 14 extends axially over a distance h from the trailing edge, and has a width E in the azimuthal direction. Moreover, each metal slat 14 is spaced by a distance L from an adjacent metal slat 14, L and E preferably being substantially equal to one another, and L and E are comprised between 10⁻⁹*h and h. It will be noted that the distances h, E and L, in other words h(θ), E(θ) and L(θ), can vary as a function of the azimuthal position θ. Preferably h(θ)/E(θ)>10.

A fourth embodiment conforming to the present disclosure will be described with reference to FIG. 12, showing a nozzle 12 trailing edge comprising chevrons 4. In this embodiment, the exhaust nozzle 12 comprises an upstream portion 124, and an annular cowling 126 detachably attached to the upstream portion 124 by attachment means 128. The attachment means 128 can comprise a first flange arranged one a downstream end of the upstream portion 124, and a second flange arranged at an upstream end of the annular cowling 126, the first and the second flange being attached to one another by screw/nut assemblies, for example, arranged at different azimuthal positions. In order to avoid separation and to limit aerodynamic losses, a protection cowling 129 having a profiled structure can be installed to cover the attachment means 128. The number of screw/nuts along the flanges can vary between 2 and 500 depending on the perimeter of the exhaust nozzle 12.

In this embodiment, the trailing edge 122 comprising the plurality of chevrons 4, is arranged on the annular cowling 126, the latter being removable and being able to be replaced, particularly in the event of damage to the chevrons 4, or simply being removed for repair.

Although the present invention has been described by referring to specific exemplary embodiments, it is obvious that modifications and changes can be carried out on these examples without departing from the general scope of the invention as defined by the claims. In particular, individual features of the different embodiments illustrated/mentioned can be combined into additional embodiments. Consequently, the description and the drawings must be considered in an illustrative, rather than a restrictive sense.

1. An aeronautical propulsion system configured to receive at least one internal air flow, comprising N stator blades, where N≥2, distributed circumferentially around the central axis, at least one exhaust nozzle through which is ejected the at least one internal air flow, extending around a central axis and being arranged downstream of the stator blades, a trailing edge of the exhaust nozzle comprising a plurality of chevrons distributed circumferentially around the central axis, said trailing edge comprising:
N first trailing edge patterns each extending, in an azimuthal direction, over an angular range Δθ including one of the N stator blades, the first trailing edge patterns being portions of the trailing edge comprising at least one chevron or being portions of the trailing edge not having a chevron, and
N second trailing edge patterns distinct from the first trailing edge patterns and extending, in the azimuthal direction, over an angular range Δθ′ including none of the N stator blades, the second trailing edge patterns being portions of the trailing edge comprising at least one chevron or being portions of the trailing edge not having a chevron, and being, the number of first trailing edge patterns distinct from one another being comprised between 1 and N, and the number of second trailing edge patterns distinct from one another being comprised between 1 and N, each angular range Δθ including one of the N stator blades being centered on a main axis of the blade which is the pitch change axis when the stator blades are variable pitch stator blades, and being such that Δθₘᵢₙ≤Δθ≤Δθₘₐₓ, where Δθₘᵢₙ=360/(36*N) and Δθₘₐₓ=360/(N+1), Δθₘᵢₙ, Δθ and Δθₘₐₓ being expressed in degrees.

2. The aeronautical propulsion system according to claim 1, wherein the first trailing edge pattern is a portion of the trailing edge comprising at least one chevron, the second trailing edge pattern being different from the first trailing edge pattern by at least one, preferably at least two among the number, the amplitude, the width, the spacing or the geometry of the chevrons.

3. The aeronautical propulsion system according to claim 1, wherein the first trailing edge pattern and/or the second trailing edge pattern are not homothetic geometric patterns.

4. The aeronautical propulsion system according to claim 1, wherein the second trailing edge pattern is a portion of the trailing edge comprising at least two chevrons.

5. The aeronautical propulsion system according to claim 1, wherein the at least one first trailing edge pattern and/or the at least one second trailing edge pattern comprises at least two chevrons with different amplitudes and/or widths and/or geometries.

6. The aeronautical propulsion system according to claim 1, wherein, when the at least one first trailing edge pattern and/or the at least one second trailing edge pattern comprise two chevrons so as to form at least one interval between said at least two chevrons, the at least one interval is filled at least partially with a porous material.

7. The aeronautical propulsion system according to claim 1, wherein, when the at least one first trailing edge pattern and/or the at least one second trailing edge pattern comprise two chevrons so as to form at least one interval between said at least two chevrons, the at least one interval is filled at least partially with a plurality of metal slats.

8. The aeronautical propulsion system according to claim 1, comprising an upstream portion, and an annular cowling configured to be detachably attached to the upstream portion, a downstream end of the annular cowling comprising the plurality of chevrons.

9. The aeronautical propulsion system according to claim 1, wherein S/C<5, where S is the distance between the trailing edge of the at least one stator blade at a connexion of the stator blade on a casing of the propulsion system and the point of the trailing edge of the exhaust nozzle closest to the stator blade in the direction of the central axis, and C is the chord of the stator blade measured at the connexion.

10. (canceled)

11. (canceled)

12. The aeronautical propulsion system according to claim 1, the aeronautical propulsion system being a ducted double flow turbojet comprising a first exhaust nozzle through which is ejected a first internal air flow and a second exhaust nozzle through which is ejected a second internal air flow, a trailing edge of each of the first and of the second exhaust nozzle comprising a plurality of chevrons, at least one first stator blade being arranged in the first internal air flow upstream of the first exhaust nozzle, and at least one second stator blade being arranged in the second internal air flow upstream of the first exhaust nozzle and of the second exhaust nozzle, the trailing edge of each of the first and second exhaust nozzle comprising at least one first trailing edge pattern and at least one second trailing edge pattern.

13. The aeronautical propulsion system according to claim 1, the aeronautical propulsion system being an unducted double flow turbojet comprising an exhaust nozzle (12′), of which an inner surface delimits the internal air flow and of which an outer surface delimits an external air flow, a trailing edge of the exhaust nozzle comprising a plurality of chevrons, at least one first stator blade being arranged in the internal air flow upstream of the exhaust nozzle.

14. The aeronautical propulsion system according to claim 11, comprising at least one second stator blade arranged in the external air flow upstream of the exhaust nozzle, the trailing edge of the exhaust nozzle comprising at least one first pattern and at least one second trailing edge pattern, the at least one first trailing edge pattern being arranged in such a manner that the angular range Δθ over which it extends includes the stator blade closest axially to the trailing edge, among the at least one first stator blade and the at least one second stator blade.
